(19) United States
(12) Patent Application Publication
(10) Pub. No.: US 2012/0185699 A1
(43) Pub. Date: Jul. 19, 2012

(54) SPACE-EFFICIENT ENCRYPTION WITH MULTI-BLOCK BINDING

(75) Inventor: Todd W. Arnold, Charlotte, NC (US)

(73) Assignee: INTERNATIONAL BUSINESS MACHINES CORPORATION, Armonk, NY (US)

(21) Appl. No.: 13/007,267

(22) Filed: Jan. 14, 2011

(51) Int. Cl. G06F 12/14

(52) U.S. Cl. 713/189

(57) ABSTRACT

Exemplary embodiments include an encryption method in a computer system having a processor and a memory operatively coupled to the processor, the method including receiving a cleartext key in the memory, the encryption key having a plurality of segments including segment K1 and segment K2, computing in the processor a hash of the segment K2, truncating in the processor the hash of the segment K2, computing in the processor an exclusive-or, K1′ of the segment K1 and the truncated hash of the segment K2, filling a buffer in the memory with K1′ followed by the segment K2 and encrypting the buffer to generate a wrapped key.

The present invention relates to cryptographic coprocessors and their cryptographic application programming interfaces (APIs) and more specifically, to systems and methods for encrypting keys with multi-block binding.

In many applications, data to be protected is encrypted using Electronic Code Book (ECB) mode of a symmetric block encryption algorithm such as Data Encryption Standard (DES) or Advanced Encryption Standard (AES). Encryption in ECB mode results in encrypted data (i.e., ciphertext), which is the same length as the unencrypted data (i.e., cleartext). As a consequence, many existing applications only allocate space for ciphertext that is the same size as the cleartext. Allocating the same space for ciphertext and clear text can be an especially serious problem for the encryption of cryptographic keys, where standards or proprietary applications and data structures limit the space for the encrypted value.

ECB mode encryption has exhibited security weaknesses. One problem is that each block (e.g., each 8 bytes in the case of DES or Triple-DES encryption) is encrypted independently of other blocks. As such, each block can be attacked independently when an adversary is attempting to decrypt the data. For adequate security, the encryption process should tie all blocks of the data together so they cannot be manipulated or attacked independently (i.e., bundling or binding). By bundling (or binding) the blocks of data, all blocks of the data are bundled (or bound) into a single logical unit.

A number of approaches that have been developed toward solving this problem tend to share a common characteristic of making the size of the encrypted data and related protection information longer than the unencrypted data. These approaches lengthen the data because the binding is accomplished by adding a new check value to the encrypted data, which allows verification that the blocks have not been manipulated in any way. While conventional methods solve the security problem of simple ECB encryption, they cause problems when trying to retrofit existing systems to use the improved methods because there is insufficient space in the data structures to hold the enlarged output of the encryption process.

### SUMMARY

Exemplary embodiments include an encryption method in a processor having a memory operatively coupled to the processor, the method including receiving a cleartext key in the memory, the encryption key having a plurality of segments including segment K1 and segment K2, computing in the processor a hash of the segment K2, truncating in the processor the hash of the segment K2, computing in the processor an exclusive-or, K1′ of the segment K1 and the truncated hash of the segment K2, filling a buffer in the memory with K1′ followed by the segment K2 and encrypting the buffer to generate a wrapped key using an encryption mode which chains each block to the preceding block. CBC (Cipher Block Chaining) mode is an example of such an encryption mode.

Additional exemplary embodiments include a computer program product for encrypting cleartext keys, the computer program product including a non-transitory computer readable medium having instructions for causing a computer having a processor and a memory to implement a method, the method including receiving a cleartext key in the memory, the encryption key having a plurality of segments including segment K1 and segment K2, computing in the processor a hash of the segment K2, truncating in the processor the hash of the segment K2, computing in the processor an exclusive-or, K1′ of the segment K1 and the truncated hash of the segment K2, filling a buffer in the memory with K1′ followed by the segment K2 and encrypting the buffer using an encryption mode which chains each block to the preceding block. CBC (Cipher Block Chaining) mode is an example of such an encryption mode.

Additional exemplary embodiments include a processor-implemented encryption method, including deriving an encryption key from a base key, where the derived key has the form of K1∥K2, K1 and K2 being eight byte segments, computing a Secure Hash Algorithm (SHA-1) hash of the segment K2, generating a 20-byte hash, truncating the hash of the segment K2 by taking leftmost eight bytes of the 20-byte hash, computing an exclusive-or, K1′ of the segment K1 and the truncated hash of the segment K2, filling a 16-byte buffer with K1′ followed by the segment K2 and encrypting the buffer in Triple Data Encryption Standard cipher block chaining mode (TDES CBC) with an initialization vector (IV) of binary zeros to generate a 16-byte wrapped key.

Further exemplary embodiments include a computer program product for encrypting cleartext keys, the computer program product including a non-transitory computer readable medium having instructions for causing a computer having a processor and a memory to implement a method, the method including deriving an encryption key from a base key where the derived key has the form of K1∥K2, K1 and K2 being eight byte segments, computing a Secure Hash Algorithm (SHA-1) hash of the segment K2, generating a 20-byte hash, truncating the hash of the segment K2 by taking leftmost eight bytes of the 20-byte hash, computing an exclusive-or, K1′ of the segment K1 and the truncated hash of the segment K2, filling a 16-byte buffer with K1′ followed by the segment K2 and encrypting the buffer in Triple Data Encryption Standard cipher block chaining mode (TDES CBC) using the derived key and an initialization vector (IV) of binary zeros to generate a 16-byte wrapped key.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates an example diagram of a double-length key, K, which is enciphered using the key-encrypting key KEK, illustrating conventional ECB key encryption methods that can be modified in accordance with exemplary embodiments;

FIG. 2 illustrates an example diagram for encrypting a double-length TDES key in accordance with exemplary embodiments;

FIG. 3 illustrates a flow chart for a method for encrypting a double-length TDES key including in accordance with exemplary embodiments;

FIG. 4 illustrates an example diagram for encrypting a triple-length TDES key in accordance with exemplary embodiments;

FIG. 5 illustrates a flow chart for a method for encrypting a triple-length TDES key in accordance with exemplary embodiments; and

FIG. 6 illustrates an exemplary embodiment of a system for encrypting keys with multi-block binding.

### DETAILED DESCRIPTION

Exemplary embodiments the systems and methods described herein combine data from separate data blocks before they are encrypted. The exemplary combination increases difficulty in manipulating the blocks separately in order to attack the cryptographic protection. The decryption process reverses the combination process to recover the original data. The systems and methods described herein address the ECB encryption security problem without expanding the size of the encrypted data beyond the size resulting from ECB encryption, thus providing a way to update the security of existing systems without the disruption of having to make major modifications to those systems. In exemplary embodiments, data that is multiple blocks in length is encrypted, while binding the data blocks together so that none can be manipulated independently, which addresses a number of cryptographic attacks that have been documented and exploited. The advantage of this method over conventional methods that are in use is that this method binds the blocks together without expanding the resulting data size. The binding provides the capability of adding improved security, while fitting the encrypted data into the buffers and databases where it resides in existing applications where ECB encryption is used.

The IBM® Common Cryptographic Architecture (CCA) is an example of a cryptographic API and is discussed herein as an example for illustrative purposes. CCA is a cryptographic architecture and API that is supported on many servers, including those in banking and finance applications. In addition, cryptograhpic coprocessors are known by a variety of terms, including Hardware Security Module (HSM) and cryptographic token, also discussed for illustrative purposes. It will be appreciated that the exemplary methods described herein can be implemented in a variety of cryptographic APIs and coprocessors.

Encryption of symmetric-algorithm keys is described as an illustrative example. It will be appreciate that the systems and methods described herein can be implemented to protect data of any kind which is any number of blocks in length. Symmetric-algorithm keys are typically encrypted in a way does not bind the individual blocks together, thereby increasing cryptographic attacks. The cryptographic keys encrypted by implementing conventional methods can be “cracked” using readily available hardware and software. In exemplary embodiments, “cracking” bound data blocks is reduced. For example, in the banking and finance industry, where cryptography is used to protect assets such as customer PINs, the standards that dictate security requirements in that industry have recently been updated to mandate stronger encryption of the information. The exemplary systems and methods described herein provide encryption that has advantages over conventional methods of encryption with block binding because the resulting encrypted keys are identical in size to those in use today, meaning that changes to the software and systems that use them are minimal. In contrast, conventional methods expand the size of the data and these systems would need much more significant changes to existing software and systems.

In exemplary embodiments, the systems and methods described herein increase security of triple-DES (TDES) keys when the keys are wrapped under a key-encrypting key (KEK). The term KEK describes all keys used to wrap other keys. Examples are keys used to wrap other keys for transport or local master keys used to protect keys for use at the local cryptographic coprocessor. As described herein, as the hardware needed to attack the single-DES algorithm has improved, the existing methods of wrapping these keys in ECB mode has become susceptible to viable attacks. Standards have been updated to prohibit the ECB key wrapping that is currently used in CCA and by other vendors who offer cryptographic products. Similarly, many conventional AES key token designs are susceptible to a subset of the same attacks. The systems and methods described herein address both DES and AES encrypted key token designs. It will also be appreciated that the systems and methods described herein apply to other encryption algorithms and modes that suffer from the same multi-block binding problems. For example, the systems and methods described here in can be implemented to block cipher algorithms, as well as other encryption algorithms in which similar block binding issues exist.

The security issues associated with conventional encryption methods exist in part because systems currently encrypt TDES keys in ECB mode. A TDES key typically includes either two 8-byte segments for a double-length key, or three 8-byte segments for a triple-length key. (For purposes of discussion, the term, “segment” is used instead of the term “part” because “part” can easily be confused with the cleartext key parts that are XORed to form complete keys in a multi-party manual key loading process.). In conventional cryptographic systems, each of the 8-byte segments is encrypted independent of the other segments. While the entire key is encrypted, the two or three separate encrypted segments are not bound to each other. This, in turn, makes it possible to rearrange the segments within a key, or to extract an encrypted segment from one key and insert it into a different key. As such, a number of attacks possible. Some techniques attempt to solve this problem by encrypting in Cipher Block Chaining (CBC) mode, which chains each block to its predecessor. As described further herein, the CBC mode is not sufficient.

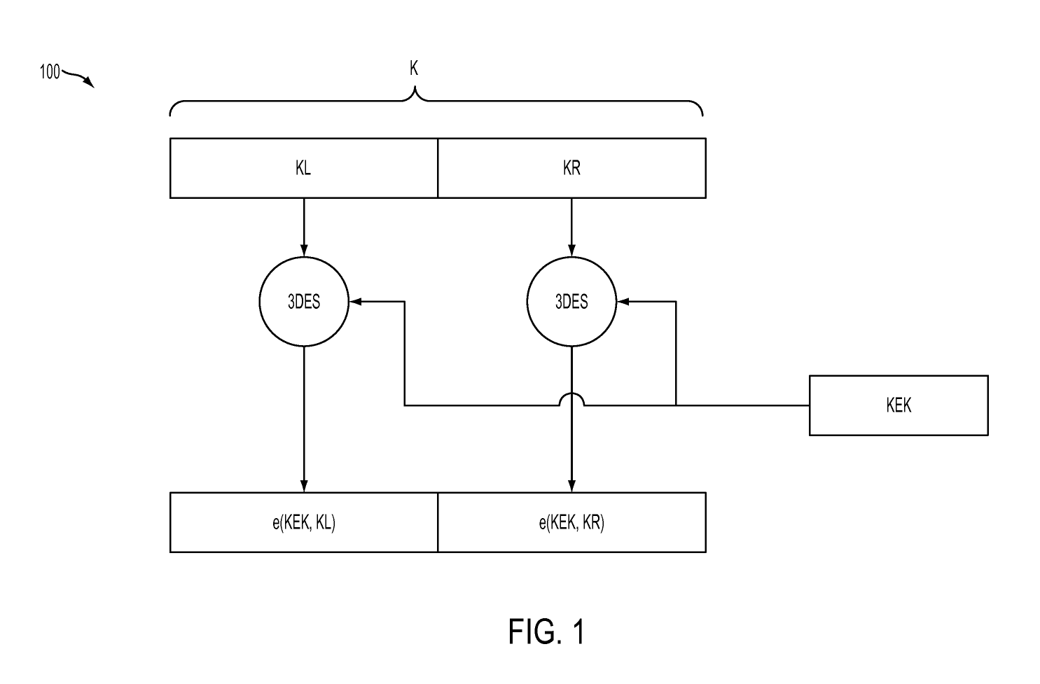

As an example, a simple attack on a double-length key, K, which is enciphered using the key-encrypting key KEK can be illustrated by referring to FIG. 1. Both keys are TDES keys which are used with the Triple-DES encryption algorithm, also known as the Triple Data Encryption Algorithm (TDEA) and as 3DES. The attacker wants to obtain the cleartext value of K. In the example, the key K is a double-length TDES key, wrapped with a double-length TDES key-encrypting key KEK. The double-length key K includes two 8-byte segments, KL, KR: K=KL∥KR, where ∥ means the concatenation of the two values KL and KR. As shown in the figure, triple DES is applied to each of the segments KL and KR, using key-encrypting key KEK as the triple DES encryption key. Those skilled in the art appreciate that FIG. 1 has been simplified. For example, when a CCA key has a control vector (CV), that CV is XORed with the KEK before using it to encrypt. CVs, key variants, or any other modifications that might be performed on the KEK have been omitted from FIG. 1. Furthermore, the KEK itself might be a transport key, a local master key or some other type of key. As such, it is appreciated that the term KEK is used in a generic sense.

Referring still to FIG. 1, the attacker has access to the encrypted key that includes an 8-byte value e(KEK, KL) and a separate 8-byte value e(KEK, KR), where e(K1, K2) means the encryption of K2 using K1. The attacker wishes to obtain the corresponding cleartext values, KL and KR. The attacker can first create a known-value cleartext double-length key. For illustrative purposes the key is referred to as A with two 8-byte segments AL and AR. The CCA API and other cryptographic APIs provide functions that can be used to load a cleartext key, and obtain the enciphered version. Thus, the attacker can obtain e(KEK, AL) and e(KEK, AR) from the cryptographic coprocessor. The attacker can replace KL with AL, which results in an encrypted key token that contains e(KEK, AL)∥e(KEK, KR). The attacker knows the cleartext value of AL, since he entered that key himself. Thus, the double-length key e(KEK, AL)∥e(KEK, KR) contains 112 bits of key material, but only 56 bits that are unknown. The attacker can then use the cryptographic coprocessor or another cryptographic resource to encrypt a piece of data D using the key, e(KEK, AL)∥e(KEK, KR). The resulting ciphertext is referred to as D′. The attacker can then perform an exhaustive search to find the value of KR, by creating keys with the segment including AL and with the other segment containing all possible 56-bit key values. With each of these keys, the attacker can attempt to decipher D′ and compare the result to the cleartext value D. If there is a match, the attacker found the correct value of KR. Once the attacker has found KR, the same steps can be performed to find the value of KL, by putting the known value e(KEK, AR) in place of e(KEK, KR) and then exhaustively searching for KL. Since the value of KR is known after the first stage of the attack process, it is also possible to find KL by exhaustive search using e(KEK, KR) instead of e(KEK, AR).

The work factor for finding each half of the key (KL and KR) is the same as the work factor for breaking a single-DES key. Thus, the total work factor to find both KL and KR is just twice the work to break a single-DES key.

The problem is that while K is a double-length (112-bit) key, it is encrypted as two separate single-length values. The solution is to bind the segments together so that they cannot be attacked separately. This issue has been recognized by customers and by the standards bodies, and the ANSI X9.24-1 key management standard has been updated to make this change mandatory; encrypting keys in ECB mode as CCA and other systems do today is now a violation of the standards against which banks and financial transaction processors are audited. ANSI X9.24-1 defines the set of requirements (ANSI uses the term “key bundling” to refer to the binding together of the key segments) and includes mandatory requirements for the bundle and individual keys. The text in part states:

“For all TDEA modes of operation, the three cryptographic keys (K1, K2, K3) define a TDEA key bundle (see Reference 3—section 6.2 options 1 and 2). Note when using double length keys, K1=K3. The bundle and the individual keys SHALL:

1. be secret;

2. be generated randomly or pseudo-randomly;

3. have integrity whereby each key in the bundle has not been altered in an unauthorized manner since the time it was generated, transmitted, or stored by an authorized source;

4. be used in the appropriate order as specified by the particular mode;

5. be considered a fixed quantity in which an individual key cannot be manipulated while leaving the other two keys unchanged; and

6. cannot be unbundled for any purpose.”

However, the current ECB key wrapping method has several problems with the requirements. For example, Requirement 4 requires assurance that the key segments K1, K2, and K3 cannot be reordered within the encrypted key. Since the segments are encrypted independently with ECB mode, this is not ensured in conventional methods. Requirement 5 says that one must not be able to replace one of the segments in the encrypted key with a different one. When the key is encrypted using ECB mode, it is possible to replace a segment in the encrypted key with a different segment. This method is one that is implemented in some of the documented attacks. Requirement 6 is in some ways a superset of the others, but again conventional ECB-encrypted keys do not satisfy this since the two or three key segments are not bound together in any way. Any of the key segments can be swapped into a different encrypted key, or the segments can be reordered. Fundamentally, the requirements are to encrypt the double-length key or triple-length key so that the entire 16-byte or 24-byte key becomes a single atomic data object which cannot be manipulated without being detected.

Another goal of the requirements is to keep the encrypted key from being any larger than it is in current key tokens such as the CCA ECB mode tokens. If the key size expands, it is difficult if to fit it into space allocated for data structures in current existing application programs, for example. Many solutions cause the length of the key and its associated data to increase. For example, an integrity check value such as a Message Authentication Code (MAC) or hash might be added, or the key could be encrypted in CBC mode using an Initialization Vector (IV) that is derived from the entire key value. Either of these examples would require additional data to be associated with the key. In exemplary embodiments, the systems and methods described herein do not expand the size of the encrypted key. Another goal is to minimize the additional overhead required to decrypt the wrapped key. Many conventional methods, such as most authenticated encryption schemes, have high overhead and would significantly increase the time required to decrypt keys before they can be used in cryptographic operations. In exemplary embodiments, the systems and methods described herein add very little overhead to the unwrapping process.

In exemplary embodiments, the systems and methods of encrypting the TDES keys described herein address the shortcomings of the conventional techniques. In exemplary embodiments, no segment of the encrypted key can be replaced with a different segment. In addition, the systems and methods described herein can be implemented for both double-length and triple-length TDES keys, and can be extended to work with data of any length. The length of the encrypted key is identical to the length of the cleartext key, as it is for the current methods of encrypting CCA keys in ECB mode.

In exemplary embodiments, the key segments of the keys are bound together so that they cannot be manipulated separately. The key segments are encrypted in TDES CBC mode, so that each segment is chained to the one preceding it. However, the first segment is only chained to the IV, which is a constant. If only CBC encryption is implemented, it would be possible to attack the first segment, which is then used to attack the second segment and so on. As such, hashes of key segments are combined into the process in order to provide the additional binding to address all of the requirements discussed herein.

In exemplary embodiments, the wrapping key implemented herein is similar to those implemented by CCA and other cryptographic APIs today. Conventionally, a base key (i.e., master key or KEK), is implemented for the wrapping key. In exemplary embodiments, instead of implementing the base key, a key that is derived from the base key is implemented. When the derived key has been created, the control vector (or a variant or other key modifier) can be applied to the derived key in the standard manner. The resulting key is implemented to wrap the new-format target key token. The derived key reduces the chance of attacks that implement existing cryptographic API functions against the exemplary wrapping. For example, an attack is possible by copying the wrapped key into an ECB CCA key token, if the wrapping key is used instead of a derivative of wrapping key.

In exemplary embodiments, the derived key is generated before applying the control vector, variant, or other modification because the cryptographic system can perform the derivation one time for the base key and keep that value for use each time the value is needed. For example, if the key is stored in the cryptographic device it can also store the derived key for later use, and if the key is received into the device for temporary use the system can cache the derived key, and if the key is used again and is in the cache, overhead is saved because the derivation does not have to be repeated.

In exemplary embodiments, key derivation can be performed in a number of ways which are understood by those skilled in cryptography. For example, the key derivation can be performed by the following methods including, but not limited to: 1) Exclusive-OR a constant value with the key; 2) Encrypt a constant value or application-dependent data with the key to produce a new key; 3) Implement a method described in NIST Special Publication 800-108, Recommendation for Key Derivation Using Pseudorandom Functions.

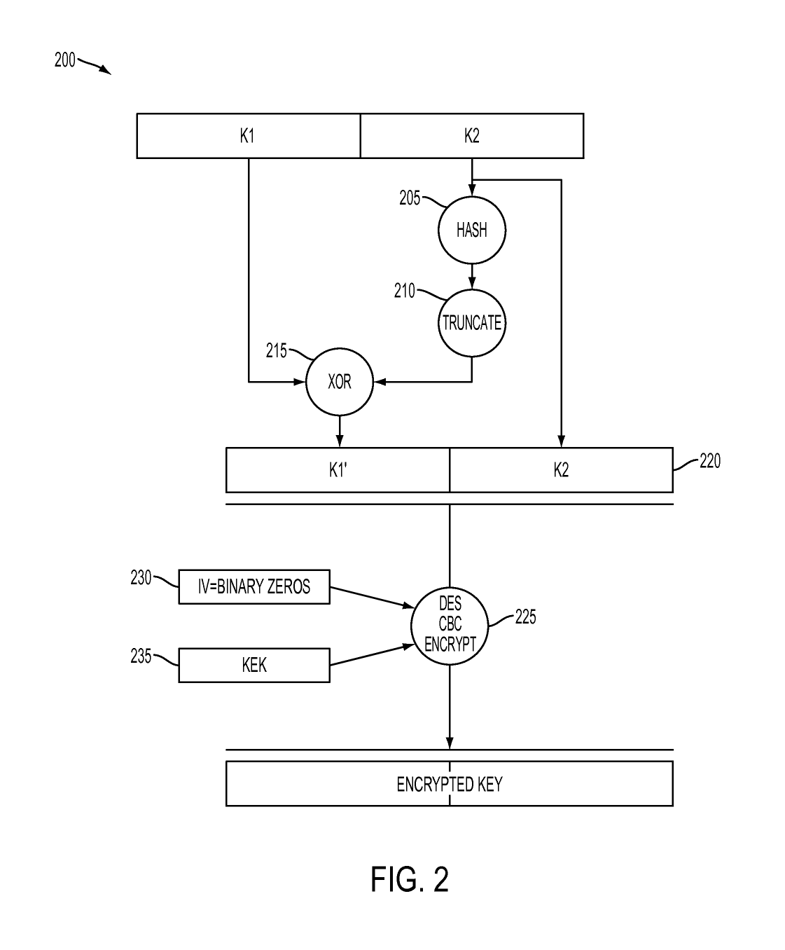

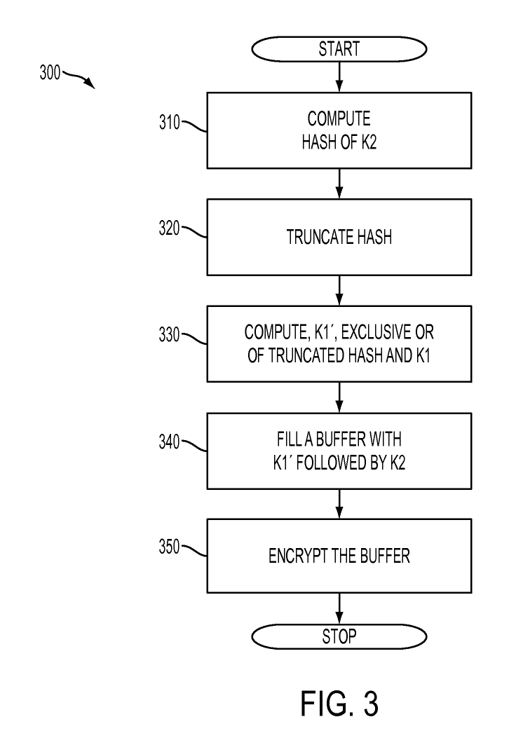

For illustrative purposes, wrapping and unwrapping double length TDES keys are first discussed to illustrate the exemplary key wrapping systems and methods. FIG. 2 illustrates an example diagram 200 for encrypting a double-length TDES key including the two segments K1 and K2 in accordance with exemplary embodiments. The double-length key K1∥K2 is derived from the base key. For example, in CCA the base key could include a CCA master key or a KEK. In either case, K1∥K2 is the result of implementing the exemplary key derivation method to derive the wrapping key and then applying the control vector, variant, or other modifier to the derived key in the standard manner. FIG. 3 illustrates a flow chart for a method 300 for encrypting a double-length TDES key including the two segments K1 and K2 in accordance with exemplary embodiments. At block 310, the method 300 computes a hash 205 of K2. For example, the hash 205 can be Secure Hash Algorithm (SHA-1) and it is appreciated that in other exemplary embodiments, other hash algorithms may be implemented. At block 320, the method 300 truncates 210 the hash to a length of eight bytes by taking leftmost bytes of the byte hash computed at block 310. The truncated length of 8 bytes matches the cipher block size for the TDES algorithm and it is appreciated that in other exemplary embodiments the truncated length might be different in order to match the cipher block length of some other encryption algorithm. At block 330, the method 300 computes the XOR 215 of K1 and the truncated hash of K2, such that K1′=K1 XOR (truncated hash of K2). At block 340, the method fills a memory buffer 220 with K1′ followed by K2. At block 350, the buffer, now 16 bytes in length, is encrypted in TDES CBC mode implementing an IV 230 of binary zeros. In addition, the key is wrapped with a double length CCA KEK 235. The resulting encrypted key is 16 bytes in length.

In exemplary embodiments, the complementary unwrapping process includes decrypting 16 byte wrapped key in TDES CBC mode implementing an IV of binary zeroes. The result is a buffer containing the values K1′ and K2 as illustrated in the encryption process in FIG. 2. The SHA-1 hash of K2 is then computed. The hash is truncated to a length of 8 bytes by taking the leftmost bytes of the 20 byte hash result. K1=K1′ XOR (truncated hash of K2) is then computed. The resulting cleartext key includes K1∥K2.

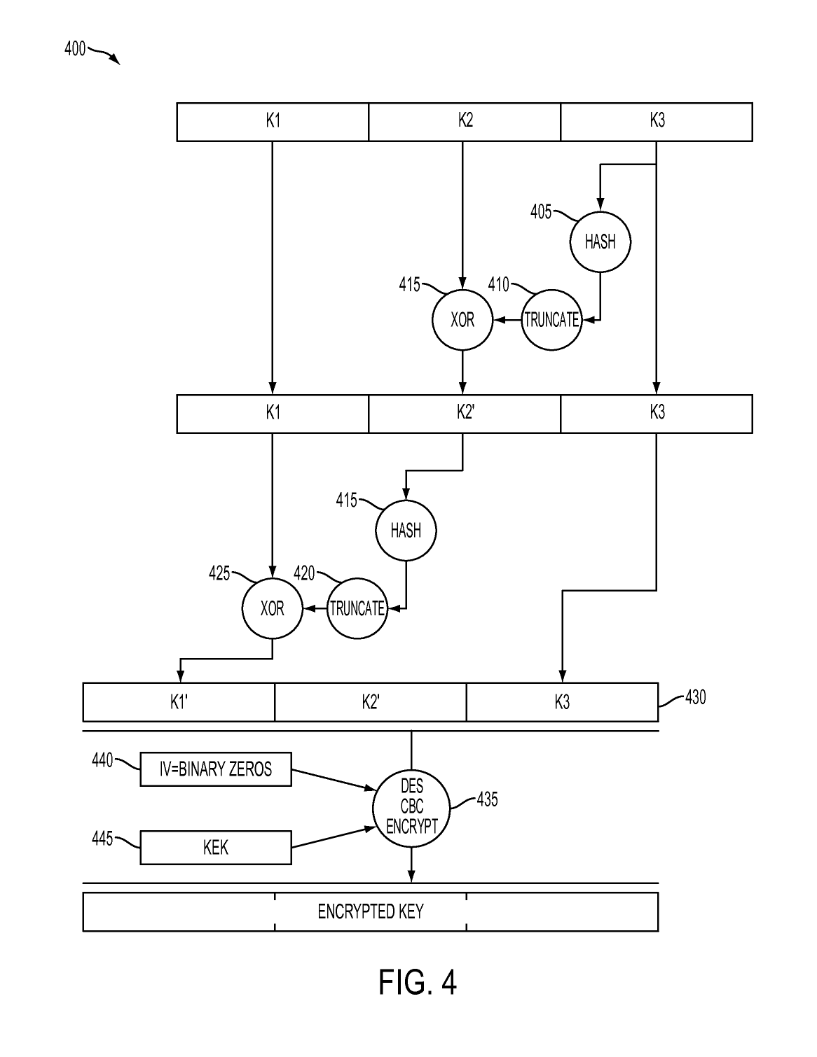

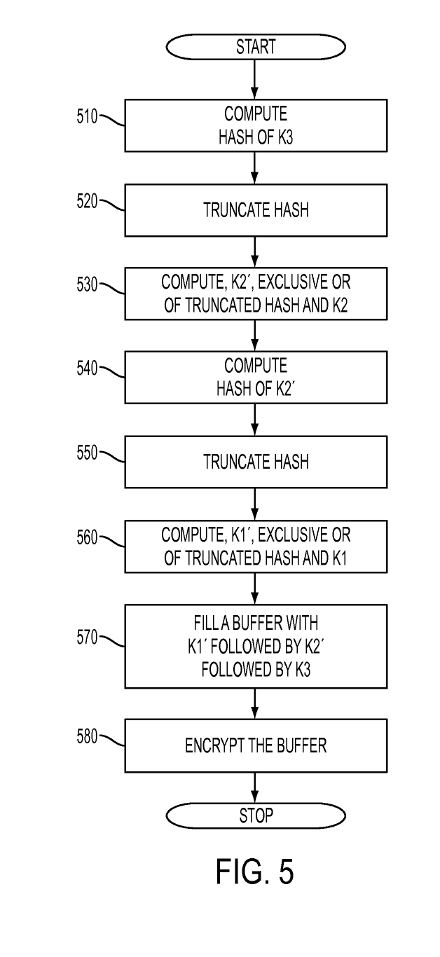

FIG. 4 illustrates an example diagram 400 for encrypting a triple-length TDES key including the three segments K1, K2 and K3 in accordance with exemplary embodiments. FIG. 5 illustrates a flow chart for a method 500 for encrypting a triple-length TDES key including the three segments K1, K2 and K3 in accordance with exemplary embodiments. At block 510, the method 500 computes a hash 405 of K3. For example, the hash 405 can be Secure Hash Algorithm (SHA-1) and it is appreciated that in other exemplary embodiments, other hash algorithms may be implemented. At block 520, the method 300 truncates 410 the hash to a length of eight bytes by taking the leftmost bytes of the byte hash computed at block 510. At block 330, the method 300 computes the XOR 215 of K2 and the truncated hash of K3, such that K2′=K2 XOR (truncated hash of K3). At block 540, the method 500 computes a hash 415 of K2′. As above, the hash 405 can be Secure Hash Algorithm (SHA-1) and it is appreciated that in other exemplary embodiments, other hash algorithms may be implemented. At block 550, the method 500 truncates 420 the hash to a length of eight bytes by taking the leftmost bytes of the byte hash computed at block 540. At block 560, the method 500 computes the XOR 425 of K1 and the truncated hash of K2′, such that K1′=K1 XOR (truncated hash of K2′). At block 570, the method 500 fills a memory buffer 430 with K1′ followed by K2′ and K3. At block 580, the buffer, now 24 bytes in length, is encrypted in TDES CBC mode using a KEK 445 and implementing an IV 440 of binary zeros.

It is appreciated that the method 500 for encrypting triple-length keys builds on the method 300 described herein for double-length keys. As such, computation of the hash, truncation of the hash and an XOR of the truncated hash into the preceding key segment can be repeated multiple times, starting with the last two segments of the key and then including each subsequent segment into the method. K1∥K2∥K3 is the result of implementing key derivation to derive the wrapping key and then applying the control vector, variant, or other modifier to the base key in the standard manner.

As described herein, the exemplary methods have been illustrated with double-length and triple-length TDES keys. The exemplary methods described herein can be generalized to handle data that is any number of 8-byte blocks in length as illustrated by the pseudocode illustrated below. The generalized method as illustrated by the pseudocode can be implemented for both double-length and triple-length keys. For example, if there is cleartext data in a buffer named “in”, and that the data is “n” 8-byte blocks in length, and there are also two buffers of the same length named “work” and “out”, then the data in buffer “in” can be encrypted as follows, with the result left in buffer “out”:
work(n)=in(n)
do I=n to 1
   h=SHA-1(in(n))
   t=leftmost 8 bytes of h
   work(i-1)=in(n-1) XOR t
end do
Encrypt the data in buffer “work” in TDES CBC mode with an IV of binary zeroes, putting the result in buffer “out”
   The complementary decryption process can be expressed as follows:
Decrypt the data in buffer “in” in TDES CBC mode with an IV of binary zeroes, putting the result in buffer “work”
out(n)=work(n)
do I=n to 1
   h=SHA-1(work(n))
   t=leftmost 8 bytes of h
   out(i-1)=work(n-1) XOR t
end do

The exemplary methods described herein have been illustrated with Triple-DES keys, which are exposed to attack because they are composed of separate 8-byte segments. However, some CBC-encrypted AES key tokens are also susceptible to a form of this same weakness. When the AES key is longer than the AES block length of 128 bits, the AES key fills two AES cipher blocks which are chained together in CBC mode. While CBC mode results in the second cipher block being bound to the first, it does not bind the first block to the second one. As a result, it is possible to attack the encrypted key by splicing the first 128 bits of a known-value encrypted AES key into a token, with the result that only the second 128-bit cipher block is unknown. A brute force attack can then be used to determine the remaining 128 bits of the key. Once the remaining 128 bits of the key are known, another brute force attack can be used to determine the first 128 bits of the key. As such, a 192-bit or 256-bit encrypted AES key can be attacked with a work factor on the order of AES-128, instead of the full intended strength. It is appreciated that any key that is believed to have 192 or 256 bit strength; the key should not be wrapped in such a way that gives it a lower strength. This issue is similar to the exposures with simple CBC-mode encryption of a triple-DES key as described herein.

As such, with these types of attacks in existence, the AES key tokens can be modified in addition to the changes described herein for Triple-DES tokens. The same methods can be applied to AES tokens: exclusive-OR a truncated hash of the second block into the cleartext of the first block before encrypting the entire key in AES CBC mode with an IV of zeroes. Also, as with the Triple-DES wrapping method, a variant of the key-wrapping key can be used when wrapping with the exemplary methods described herein. Unlike the Triple-DES problem, the current AES encryption method does not violate any standards. However, the current standards in this area do not yet include AES.

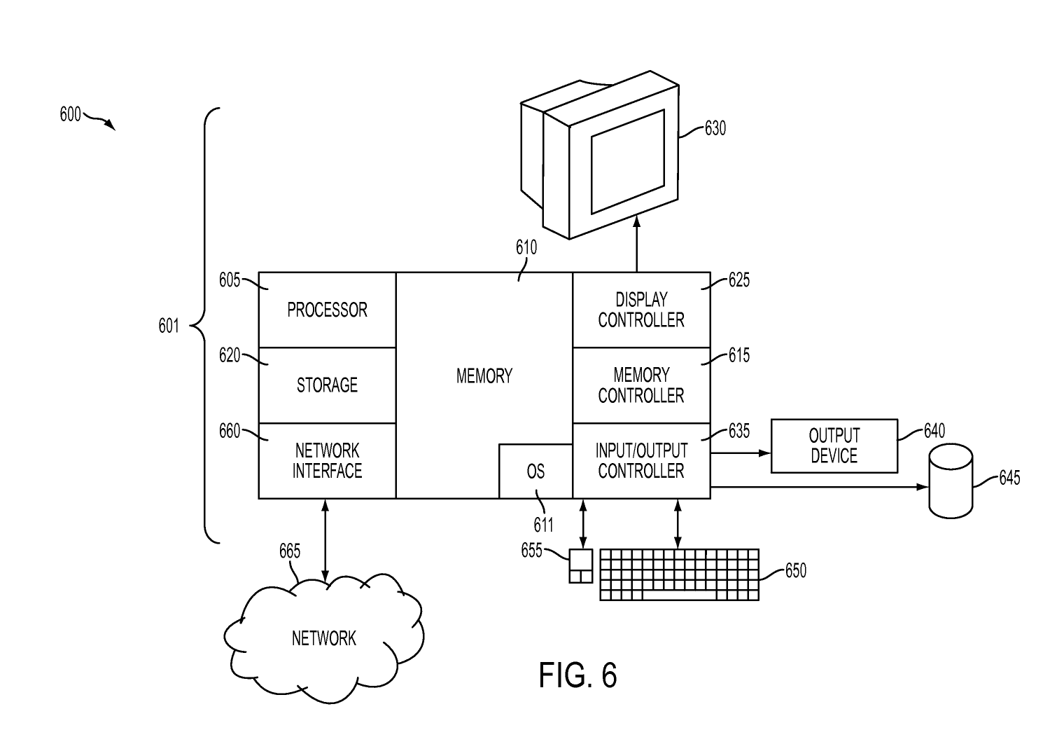

The exemplary methods described herein and associated CCA API can be implemented in any suitable computer system in which encryption is desired. FIG. 6 illustrates an exemplary embodiment of a system 600 for encrypting keys with multi-block binding. The methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 600 therefore includes general-purpose computer 601.

In exemplary embodiments, in terms of hardware architecture, as shown in FIG. 6, the computer 601 includes a processor 605, memory 610 coupled to a memory controller 615, and one or more input and/or output (I/O) devices 640, 645 (or peripherals) that are communicatively coupled via a local input/output controller 635. The input/output controller 635 can be, but is not limited to, one or more buses or other wired or wireless connections, as is known in the art. The input/output controller 635 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 605 is a hardware device for executing software, particularly that stored in memory 610. The processor 605 can be any custom made or commercially available processor, a central processing unit (CPU), an auxiliary processor among several processors associated with the computer 601, a semiconductor based microprocessor (in the form of a microchip or chip set), a macroprocessor, or generally any device for executing software instructions.

The memory 610 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 610 may incorporate electronic, magnetic, optical, and/or other types of storage media. Note that the memory 610 can have a distributed architecture, where various components are situated remote from one another, but can be accessed by the processor 605.

The software in memory 610 may include one or more separate programs, each of which comprises an ordered listing of executable instructions for implementing logical functions. In the example of FIG. 6, the software in the memory 610 includes the encryption methods described herein in accordance with exemplary embodiments and a suitable operating system (OS) 611. The operating system 611 essentially controls the execution of other computer programs, such the encryption systems and methods as described herein, and provides scheduling, input-output control, file and data management, memory management, and communication control and related services.

The encryption methods described herein may be in the form of a source program, executable program (object code), script, or any other entity comprising a set of instructions to be performed. When a source program, then the program needs to be translated via a compiler, assembler, interpreter, or the like, which may or may not be included within the memory 610, so as to operate properly in connection with the OS 611. Furthermore, the encryption methods can be written as an object oriented programming language, which has classes of data and methods, or a procedure programming language, which has routines, subroutines, and/or functions.

In exemplary embodiments, a conventional keyboard 650 and mouse 655 can be coupled to the input/output controller 635. Other output devices such as the I/O devices 640, 645 may include input devices, for example but not limited to a printer, a scanner, microphone, and the like. Finally, the I/O devices 640, 645 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 600 can further include a display controller 625 coupled to a display 630. In exemplary embodiments, the system 600 can further include a network interface 660 for coupling to a network 665. The network 665 can be an IP-based network for communication between the computer 601 and any external server, client and the like via a broadband connection. The network 665 transmits and receives data between the computer 601 and external systems. In exemplary embodiments, network 665 can be a managed IP network administered by a service provider. The network 665 may be implemented in a wireless fashion, e.g., using wireless protocols and technologies, such as WiFi, WiMax, etc. The network 665 can also be a packet-switched network such as a local area network, wide area network, metropolitan area network, Internet network, or other similar type of network environment. The network 665 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 601 is a PC, workstation, intelligent device or the like, the software in the memory 610 may further include a basic input output system (BIOS) (omitted for simplicity). The BIOS is a set of essential software routines that initialize and test hardware at startup, start the OS 611, and support the transfer of data among the hardware devices. The BIOS is stored in ROM so that the BIOS can be executed when the computer 601 is activated.

When the computer 601 is in operation, the processor 605 is configured to execute software stored within the memory 610, to communicate data to and from the memory 610, and to generally control operations of the computer 601 pursuant to the software. The encryption methods described herein and the OS 611, in whole or in part, but typically the latter, are read by the processor 605, perhaps buffered within the processor 605, and then executed.

When the systems and methods described herein are implemented in software, as is shown in FIG. 6, the methods can be stored on any computer readable medium, such as storage 620, for use by or in connection with any computer related system or method.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In exemplary embodiments, where the encryption methods are implemented in hardware, the encryption methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Technical effects include binding of data blocks together without expanding the resulting data size, which provides the capability of adding improved security, while still fitting the encrypted data into the buffers and databases where data resides currently.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one ore more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. In a processor having memory operatively coupled to the processor, an encryption method, comprising:
receiving a cleartext key in the memory, the encryption key having a plurality of segments including segment K1 and segment K2;
computing in the processor a hash of the segment K2;
truncating in the processor the hash of the segment K2;
computing in the processor an exclusive-or, K1′ of the segment K1 and the truncated hash of the segment K2;
filling a buffer in the memory with K1′ followed by the segment K2; and
encrypting the buffer to generate a wrapped key.

2. The method as claimed in claim 1 wherein the segments K1 and K2 are each eight bytes in length.

3. The method as claimed in claim 1 wherein the hash of the segment of K2 is a Secure Hash Algorithm (SHA-1) hash of the segment K2.

4. The method as claimed in claim 1 wherein the buffer in the memory is a sixteen byte buffer.

5. The method as claimed in claim 1 wherein the buffer is encrypted in Triple Data Encryption Standard (TDES) Cipher Block Chaining (CBC) mode.

6. The method as claimed in claim 5 wherein the buffer is encrypted in TDES CBC mode with an initialization vector (IV) of binary zeros.

7. The method as claimed in claim 1 wherein the buffer is encrypted using the Advanced Encryption Standard (AES) algorithm.

8. The method as claimed in claim 1 wherein the cleartext key is a double-length TDES key in the form K1∥K2 and includes a base key, wherein a wrapping key is generated from a derivative from the base key.

9. The method as claimed in claim 1 wherein the cleartext key is a Triple-length TDES key.

10. The method as claimed in claim 1 further comprising unwrapping the wrapped key, including:
decrypting the encrypted buffer
computing in the processor a hash of the segment K2 and truncating the hash of the segment K2 to a length of eight bytes; and
computing in the processor an exclusive-or of K1′ and the truncated hash of the segment K2 to obtain the segment K1.

11. A computer program product for encrypting cleartext keys, the computer program product including a non-transitory computer readable medium having instructions for causing a computer having a processor and a memory to implement a method, the method comprising:
receiving a cleartext key in the memory, the encryption key having a plurality of segments including segment K1 and segment K2;
computing in the processor a hash of the segment K2;
truncating in the processor the hash of the segment K2;
computing in the processor an exclusive-or, K1′ of the segment K1 and the truncated hash of the segment K2;
filling a buffer in the memory with K1′ followed by the segment K2; and
encrypting the buffer.

12. The computer program product as claimed in claim 11 wherein the segments K1 and K2 are each eight bytes in length.

13. The computer program product as claimed in claim 11 wherein the hash of the segment of K2 is a Secure Hash Algorithm (SHA-1) hash of the segment K2.

14. The computer program product as claimed in claim 11 wherein the buffer in the memory is a sixteen byte buffer.

15. The computer program product as claimed in claim 11 wherein the buffer is encrypted in Triple Data Encryption Standard Cipher Block Chaining (CBC) mode.

16. The computer program product as claimed in claim 15 wherein the buffer is encrypted in TDES CBC mode with an initialization vector (IV) of binary zeros.

17. The method as claimed in claim 11 wherein the buffer is encrypted using the Advanced Encryption Standard (AES) algorithm.

18. The computer program product as claimed in claim 11 wherein the cleartext key is a double-length TDES key in the form K1∥K2 and includes a base key, wherein a wrapping key is generated from a derivative from the base key.

19. The computer program product as claimed in claim 11 wherein the cleartext key is a triple-length TDES key.

20. The computer program product as claimed in claim 11 wherein the method further comprises unwrapping the wrapped key, including:
decrypting the encrypted buffer computing in the processor a hash of the segment K2 and truncating the hash of the segment K2 to a length of eight bytes; and
computing in the processor an exclusive-or of K1′ and the truncated hash of the segment K2 to obtain the segment K1.

21. A processor-implemented encryption method, comprising:
deriving an encryption key from a base key, in the form of K1∥K2, K1 and K2 being eight byte segments;
computing a Secure Hash Algorithm (SHA-1) hash of the segment K2, generating a 20-byte hash;
truncating the hash of the segment K2 by taking leftmost eight bytes of the 20-byte hash;
computing an exclusive-or, K1′ of the segment K1 and the truncated hash of the segment K2;
filling a 16-byte buffer with K1′ followed by the segment K2; and
encrypting the buffer in Triple Data Encryption Standard Cipher Block Chaining (CBC) mode with an initialization vector (IV) of binary zeros to generate a 16-byte wrapped key.

22. The method as claimed in claim 21 further comprising:
decrypting the 16-byte wrapped key to yield a buffer including K1′ and K2;
computing a SHA-1 hash of K2 to yield a 20-byte hash result;
truncating the SHA-1 hash of K2 to a length of eight bytes by taking the leftmost eight bytes of the 20-byte hash result;
computing an exclusive-or, of K1′ and the truncated hash of K2 to yield the segment K1; and
generating the cleartext key in the form of K1∥K2.

23. A computer program product for encrypting cleartext keys, the computer program product including a non-transitory computer readable medium having instructions for causing a computer having a processor and a memory to implement a method, the method comprising:
deriving an encryption key from a base key, in the form of K1∥K2, K1 and K2 being eight byte segments;
computing a Secure Hash Algorithm (SHA-1) hash of the segment K2, generating a 20-byte hash;
truncating the hash of the segment K2 by taking leftmost eight bytes of the 20-byte hash;
computing an exclusive-or, K1′ of the segment K1 and the truncated hash of the segment K2;
filling a 16-byte buffer with K1′ followed by the segment K2; and
encrypting the buffer in Triple Data Encryption Standard Cipher Block Chaining (CBC) mode with an initialization vector (IV) of binary zeros to generate a 16-byte wrapped key.

24. The computer program product as claimed in claim 21 wherein the method further comprises:
decrypting the 16-byte wrapped key to yield a buffer including K1′ and K2;
computing a SHA-1 hash of K2 to yield a 20-byte hash result;
truncating the SHA-1 hash of K2 to a length of eight bytes by taking the leftmost eight bytes of the 20-byte hash result;
computing an exclusive-or, of K1′ and the truncated hash of K2 to yield the segment K1; and
generating the cleartext key in the form of K1∥K2.
